(19) United States
(12) Patent Application Publication
(10) Pub. No.: US 2026/0250476 A1
(43) Pub. Date: Aug. 27, 2026

(54) FOAMED PROPYLENE-BASED ELASTOMER COMPOSITIONS, METHODS FOR MAKING AND PRODUCTS MADE THEREFROM

(71) Applicant: EXXONMOBIL TECHNOLOGY AND ENGINEERING COMPANY, Spring, TX (US)

(72) Inventors: Jie Yu JIN, Shanghai (CN); Yan WANG, Guangzhou (CN); Haibin QIU, Shanghai (CN); Yujie SHENG, Shanghai (CN); Liang LI, Shanghai (CN); Hai Yin HUA, Shanghai (CN); Hongchao WANG, Shanghai (CN); Yaxian WANG, Shanghai (CN); Tao TANG, Changchun (CN); Minggang LI, Changchun (CN)

(21) Appl. No.: 19/159,532

(22) PCT Filed: Feb. 12, 2024
(86) PCT No.: PCT/US2024/015343

§ 371 Date: Aug. 25, 2025

Related U.S. Application Data
(60) Provisional application No. 63/488,467, filed on Mar. 3, 2023.

(51) Int. Cl. C08J 9/232; C08J 9/00; C08J 9/12; C08J 9/18; C08L 23/12

(52) U.S. Cl. CPC C08J 9/232; C08J 9/0061; C08J 9/122; C08J 9/18; C08L 23/12; C08J 2203/06; C08J 2205/04; C08J 2323/12; C08J 2423/14; C08L 2203/14; C08L 2205/025

(57) ABSTRACT

Foamed polymer compositions and products made therefrom are disclosed, More particularly, foamed polymer compositions including propylene-based elastomers, The compositions including such propylene-based elastomers require less energy to mold, without sacrifice performance of the foamed product.

### CROSS-REFERENCE TO RELATED APPLICATION

This application claims the benefit of U.S. Provisional Application 63/488,467 filed Mar. 3, 2023 entitled, Foamed Propylene-Based Elastomer Compositions, Methods for Making and Products Made Therefrom, the entirety of which is incorporated by reference herein.

### FIELD OF THE INVENTION

Embodiments of the present invention generally relate foamed polymer compositions and products made therefrom. More particularly, such embodiments relate to foamed polymer compositions made from propylene-based elastomers.

### BACKGROUND OF THE INVENTION

Expanded beads are a physical foamed product, which is widely used in industrial packaging or automotive applications. Normally EPP (expanded polypropylene) is used to replace carton boxes in the packaging industry or used as a part of a rear seat to reduce weight in automobiles. EPS (expanded polystyrene) is typically used to protect items in packaging during transit. EPP typically has better mechanical properties than EPS, and EPP can be recycled and reused, which is more sustainable as compared to EPS. As such, there is a trend in the industry for more EPP to replace EPS and other formats of packaging.

Currently RCP (random copolymer) or terPP is used as a raw material to produce EPP. After the expanded beads are produced, the beads are typically molded using steam. Due to the vicat temperature or melting temperature of the EPP, the steam pressure requirement is typically 2-3 kg/cm² to provide the temperature needed to mold the EPP beads. The energy cost of the steam is can be as much as half of the total cost of the final product.

Therefore, there is a need for expanded beads made of another polymer material that requires less energy to mold, and that will not sacrifice performance of the product.

References to be included in an Invention Disclosure Statement: CN105885241A, CN105885242A, CN107828134B, US2020-0181350.

### SUMMARY OF THE INVENTION

A foamable polymer composition is disclosed, which includes at least 5 wt %, based on the total weight of the composition, of at least one propylene-based elastomer comprising propylene and about 15 wt % to about 30 wt % of one or more alpha-olefin derived units, based on a total weight of the elastomer, wherein the propylene-based elastomer has a MFR of at least 3 g/10 min and a heat of fusion (Hf) of about 3 J/g to about 75 J/g, as determined by DSC, less than 95 wt %, based on the total weight of the composition, of at least one polypropylene, and a foaming agent; wherein, prior to combination with the foaming agent, the polymer blend has a density of at least 0.80 g/cm³ and after the blend is foamed, the foamed article has a density of 0.2 g/cm³ or less.

A foamed bead includes at least 80 wt %, based on the total weight of the foamed bead, of a propylene-based elastomer comprising propylene and about 15 wt % to about 30 wt % of one or more alpha-olefin derived units, based on a total weight of the elastomer, wherein the propylene-based elastomer has a MFR of at least 3 g/10 min and a heat of fusion (Hf) of about 3 J/g to about 75 J/g, as determined by DSC.

A process for producing a foamed polymer composition includes mixing a foaming agent with a molten polymer composition to form a foamable mixture, forming said foamable mixture so that said foaming agent expands within said mixture to produce a foam, and obtaining a foamed article having has a density of 0.11 g/cm³ or less, wherein the molten polymer composition comprises the composition of claim 1.

A process for producing a foamed bead article includes introducing a plurality of foamed beads to a mold, increasing the pressure within the mold to an elevated pressure from 0.1-0.5 MPa, heating the foamed beads within the mold to an elevated temperature from 35-125° C., maintaining the elevated pressure and elevated temperature for a compression time to form the foamed bead article, and releasing the article.

### BRIEF DESCRIPTION OF THE DRAWINGS

So that the manner in which the above recited features of the present invention can be understood in detail, a more particular description of the invention, briefly summarized above, can be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. It is emphasized that the figures are not necessarily to scale and certain features and certain views of the figures can be shown exaggerated in scale or in schematic for clarity and/or conciseness.

FIG. 1 is a schematic of a bead foaming device.

FIG. 2A is a SEM of the foamed Sheet #1 of Example 1.

FIG. 2B is an enlarged view of the SEM depicted in FIG. 1.

FIG. 3 is a DSC curve of sample EFB-003.

FIG. 4 is a DSC curve of sample EFB-006.

FIG. 5 is a DSC curve of sample EFB-013.

FIG. 6 is a photograph of steam molded samples of (A) EFB-003 and (B) EFB-006.

FIG. 7 is a photograph of a steam molded sample of EFB-013.

FIG. 8 is a DSC curve of a sample of an EFB including PBE3.

FIG. 9 is an SEM image of an EFB including PBE3.

FIG. 10A is a photograph of a steam molded sample of PBE EFBs.

FIG. 10B is a photograph of a cross section of a steam-molded sample of PBE.EFBs.

FIG. 11 is a DSC curve of an EFB including PBE3.

FIG. 12 is a DSC curve of an EFB including PBE2.

FIG. 13 is a schematic of a simplified compression molding process.

### DETAILED DESCRIPTION OF THE INVENTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various embodiments and across the figures provided herein. This repetition is for the purpose of simplicity and clarity and does not in itself dictate a relationship between the various embodiments and/or configurations. Moreover, the formation of a first feature over or on a second feature in the description that follows can include embodiments in which the first and second features are formed in direct contact, and can also include embodiments in which additional features can be formed interposing the first and second features, such that the first and second features are not in direct contact. Finally, the embodiments presented below can be combined in any combination of ways, i.e., any element from one embodiment can be used in any other embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

In the following discussion and in the claims, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case does not include any other component to a level greater than 3 mass %.

The term “or” is intended to encompass both exclusive and inclusive cases, i.e., “A or B” is intended to be synonymous with “at least one of A and B,” unless otherwise expressly specified herein. The indefinite articles “a” and “an” refer to both singular forms (i.e., “one”) and plural referents (i.e., one or more) unless the context clearly dictates otherwise. For example, embodiments using “an olefin” include embodiments where one, two, or more olefins are used, unless specified to the contrary or the context clearly indicates that only one olefin is used.

The term “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

The term “polymer” refers to any two or more of the same or different repeating units/mer units or units. The term “homopolymer” refers to a polymer having units that are the same. The term “copolymer” refers to a polymer having two or more units that are different from each other, and includes terpolymers and the like. The term “terpolymer” refers to a polymer having three units that are different from each other. The term “different” as it refers to units indicates that the units differ from each other by at least one atom or are different isomerically. Likewise, the definition of polymer, as used herein, includes homopolymers, copolymers, and the like. By way of example, when a copolymer is said to have a “propylene” content of 10 wt % to 30 wt %, it is understood that the repeating unit/mer unit or simply unit in the copolymer is derived from propylene in the polymerization reaction and the derived units are present at 10 wt % to 30 wt %, based on a weight of the copolymer.

The term “α-olefin” refers to any linear or branched compound of carbon and hydrogen having at least one double bond between the α and β carbon atoms. For purposes of this specification and the claims appended thereto, when a polymer or copolymer is referred to as including an α-olefin, e.g., poly-α-olefin, the α-olefin present in such polymer or copolymer is the polymerized form of the α-olefin.

Nomenclature of elements and groups thereof used herein are pursuant to the Periodic Table used by the International Union of Pure and Applied Chemistry after 1988. An example of the Periodic Table is shown in the inner page of the front cover of Advanced Inorganic Chemistry, 6th Edition, by F. Albert Cotton et al. (John Wiley & Sons, Inc., 1999).

As used herein, the terms “monomer” or “comonomer,” can refer to the monomer used to form the polymer, e.g., the unreacted chemical compound in the form prior to polymerization, and can also refer to the monomer after it has been incorporated into the polymer, also referred to herein as a “[monomer]-derived unit”.

The term “copolymer” is meant to include polymers having two or more monomers, optionally, with other monomers, and may refer to interpolymers, terpolymers, etc. The term “polymer” as used herein includes, but is not limited to, homopolymers, copolymers, terpolymers, etc., and alloys and blends thereof. The term “polymer” as used herein also includes impact, block, graft, random, and alternating copolymers. The term “polymer” shall further include all possible geometrical configurations unless otherwise specifically stated. Such configurations can include isotactic, syndiotactic and random symmetries.

The term “polymer” refers to any two or more of the same or different repeating units/mer units or units. The term “blend” as used herein refers to a mixture of two or more polymers. The term “homopolymer” refers to a polymer having units that are the same. The term “copolymer” refers to a polymer having two or more units that are different from each other, and includes terpolymers and the like. The term “terpolymer” refers to a polymer having three units that are different from each other. The term “different” as it refers to units indicates that the units differ from each other by at least one atom or are different isomerically. Likewise, the definition of polymer, as used herein, includes homopolymers, copolymers, and the like. By way of example, when a copolymer is said to have a “propylene” content of 10 wt % to 30 wt %, it is understood that the repeating unit/mer unit or simply unit in the copolymer is derived from propylene in the polymerization reaction and the derived units are present at 10 wt % to 30 wt %, based on a weight of the copolymer.

The term “elastomer” shall mean any polymer exhibiting some degree of elasticity, where elasticity is the ability of a material that has been deformed by a force (such as by stretching) to return at least partially to its original dimensions once the force has been removed.

The terms “α-olefin” or “alpha olefin” refers to any linear or branched compound of carbon and hydrogen having at least one double bond between the α and β carbon atoms. For purposes of this specification and the claims appended thereto, when a polymer or copolymer is referred to as including an α-olefin, e.g., poly-α-olefin, the α-olefin present in such polymer or copolymer is the polymerized form of the α-olefin.

A detailed description of a foamed propylene based elastomer and methods for using the same will now be provided. Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

The foamed compositions can be injection molded or compression molded into a desired shape and then physically foamed by any one or more chemical or physical foaming techniques. The foamed compositions also can be made by single screw compounding, twin screw compounding, kneader/banbury mixing or similar techniques. According to the embodiments provided herein, the foamed product is lighter weight and less dense than mechanically comparable products made from expanded polypropylene, polystyrene or RCPs and are particularly useful for footwear, e.g. slippers or mid-sole; packaging, Yoga mats, and other consumer products.

The foamed composition can be or can include a blend or two or more propylene based elastomers and one or more polypropylenes. A propylene-based elastomer is a random copolymer having crystalline regions interrupted by non-crystalline regions and within the range from 5 to 25 wt %, by weight of the propylene-based elastomer, of ethylene or C4 to C10 α-olefin derived units, and optionally diene-derived units, the remainder of the polymer being propylene-derived units. Not intended to be limited by any theory, it is believed that the non-crystalline regions can result from regions of non-crystallizable polypropylene segments and/or the inclusion of comonomer units. The crystallinity and the melting point of the propylene-based elastomer are reduced compared to highly isotactic polypropylene by the introduction of errors (stereo and region defects) in the insertion of propylene and/or by the presence of comonomer. The copolymer contains at least 60 wt % propylene-derived units by weight of the propylene-based elastomer. In any embodiment, the propylene-based elastomer is a propylene-based elastomer having limited crystallinity due to adjacent isotactic propylene units and a melting point as described herein. In other embodiments, the propylene-based elastomer is generally devoid of any substantial intermolecular heterogeneity in tacticity and comonomer composition, and also generally devoid of any substantial heterogeneity in intramolecular composition distribution.

In certain embodiments, the PBE contains at least 60 wt % propylene and from about 5 wt % to about 30 wt % of one or more alpha-olefin derived units, for example, ethylene and/or C4-C12 α-olefins. In some examples, the alpha-olefin derived units, or comonomer, can be ethylene, butene, pentene, hexene, 4-methyl-1-pentene, octene, or decene. In one or more examples, the comonomer is ethylene. In some embodiments, the PBE consists essentially of propylene and ethylene, or consists only of propylene and ethylene. Some of the embodiments described below are discussed with reference to ethylene as the comonomer, but the embodiments are equally applicable to PBEs with other α-olefin comonomers. In this regard, the copolymers may simply be referred to as PBEs with reference to ethylene as the α-olefin.

The comonomer can be ethylene, 1-hexene, or 1-octene, and preferably in an amount of 3, 5, 10, or 14 wt % to 15, 20, 22, or 25 wt %, based on the total weight of the propylene-based elastomer. The comonomer content of the propylene-based elastomer can also range from about 3 to about 35 wt %; about 3 to 15 wt %; and about 10 to 15 wt %, based on the total weight of the propylene-based elastomer.

The propylene-based elastomer can include 3, 5, 10, or 14 wt % to 15, 20, 22, or 25 wt % of ethylene-derived units, based on the total weight of the propylene-based elastomer. The ethylene content of the propylene-based elastomer can also range from about 3 to about 35 wt %; about 3 to 15 wt %; and about 10 to 15 wt %, based on the total weight of the propylene-based elastomer. In any embodiment, the propylene-based elastomer consists essentially of units derived from propylene and ethylene, i.e., the propylene-based elastomer does not contain any other comonomer in an amount typically present as impurities in the ethylene and/or propylene feedstreams used during polymerization or an amount that would materially affect the heat of fusion, melting point, crystallinity, or melt flow rate of the propylene-based elastomer, or any other comonomer intentionally added to the polymerization process.

Diene comonomer units can be included in the propylene-based elastomer. Examples of suitable dienes include, but not limited to, 5-ethylidene-2-norbornene, 5-vinyl-2-norbornene, divinylbenzene, 1,4-hexadiene, 5-methylene-2-norbornene, 1,6-octadiene, 5-methyl-1, 4-hexadiene, 3,7-dimethyl-1,6-octadiene, 1,3-cyclopentadiene, 1,4-cyclohexadiene, dicyclopentadiene, or a combination thereof. The amount of diene comonomer can be equal to or more than 0 wt %, or 0.5 wt %, or 1 wt %, or 1.5 wt % and lower than, or equal to, 5 wt %, or 4 wt %, or 3 wt % or 2 wt % based on the weight of propylene-based elastomer.

The PBE can include at least about 5 wt %, at least about 6 wt %, at least about 7 wt %, at least about 8 wt %, at least about 9 wt %, at least about 10 wt %, at least about 12 wt %, or at least about 15 wt %, α-olefin-derived units, where the percentage by weight is based upon the total weight of the propylene-derived and α-olefin-derived units. The PBE can include up to about 30 wt %, up to about 25 wt %, up to about 22 wt %, up to about 20 wt %, up to about 19 wt %, up to about 18 wt %, or up to about 17 wt %, α-olefin-derived units, where the percentage by weight is based upon the total weight of the propylene-derived and α-olefin-derived units. In some embodiments, the PBE may contain from about 5 wt % to about 30 wt %, from about 6 wt % to about 25 wt %, from about 7 wt % to about 20 wt %, from about 10 wt % to about 19 wt %, from about 12 wt % to about 18 wt %, or from about 15 wt % to about 17 wt %, α-olefin-derived units, where the percentage by weight is based upon the total weight of the propylene-derived and α-olefin-derived units.

The PBE can include at least 50 wt %, at least 70 wt %, at least 75 wt %, at least 78 wt %, at least 80 wt %, at least 81 wt %, at least 82 wt %, or at least 83 wt %, propylene-derived units, where the percentage by weight is based upon the total weight of the propylene-derived and α-olefin derived units. The PBE can include up to about 95 wt %, up to about 94 wt %, up to about 93 wt %, up to about 92 wt %, up to about 91 wt %, up to about 90 wt %, up to about 88 wt %, or up to about 85 wt %, propylene-derived units, where the percentage by weight is based upon the total weight of the propylene-derived and α-olefin derived units.

The PBEs can be characterized by a melting point (Tm), which can be determined by differential scanning calorimetry (DSC). For purposes herein, the maximum of the highest temperature peak is considered to be the melting point of the polymer. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak. The Tm of the PBE (as determined by DSC) can be less than 120° C., less than 115° C., less than 110° C., or less than 105° C.

The PBE can be characterized by its heat of fusion (Hf), as determined by DSC. The PBE may have an Hf that is at least about 0.5 J/g, at least about 1.0 J/g, at least about 1.5 J/g, at least about 3.0 J/g, at least about 4.0 J/g, at least about 5.0 J/g, at least about 6.0 J/g, or at least about 7.0 J/g. The PBE can be characterized by an Hf of less than 75 J/g, or less than 70 J/g, or less than 60 J/g, or less than 50 J/g. In one or more examples, the PBE has a melting temperature of less than 120° C. and a heat of fusion of less than 75 J/g.

As used within this specification, DSC procedures for determining Tm and Hf are as follows. The polymer is pressed at a temperature of about 200° C. to about 230° C. in a heated press, and the resulting polymer sheet is hung, under ambient conditions, in the air to cool. About 6 mg to about 10 mg sample of the polymer sheet is removed with a punch die. This sample is annealed at room temperature (about 23° C.) for about 80 hours to about 100 hours. At the end of this period, the sample is placed in a DSC (Perkin Elmer Pyris One Thermal Analysis System) and cooled to about −30° C. to about −50° C. and held for 10 minutes at that temperature. The sample is then heated at 10° C./min to attain a final temperature of about 200° C. The sample is kept at 200° C. for 5 minutes. Then a second cool-heat cycle is performed, where the sample is again cooled to about −30° C. to about −50° C. and held for 10 minutes at that temperature, and then re-heated at 10° C./min to a final temperature of about 200° C. Events from both cycles are recorded. The thermal output is recorded as the area under the melting peak of the sample, which typically occurs between about 0° C. and about 200° C. It is measured in Joules and is a measure of the Hf of the polymer.

The PBE can have a triad tacticity of three propylene units (mm tacticity), as measured by 13C NMR, of 75% or greater, 80% or greater, 85% or greater, 90% or greater, 92% or greater, 95% or greater, or 97% or greater. For example, the triad tacticity may range from about 75% to about 99%, from about 80% to about 99%, from about 85% to about 99%, from about 90% to about 99%, from about 90% to about 97%, or from about 80% to about 97%. Triad tacticity can be determined by the methods described in U.S. Pat. No. 7,232,871.

The PBE may have a tacticity index m/r ranging from a lower limit of 4 or 6 to an upper limit of 8 or 10 or 12. The tacticity index, expressed herein as “m/r”, is determined by 13C nuclear magnetic resonance (“NMR”). The tacticity index, m/r, is calculated as defined by H. N. Cheng in Vol. 17, MACROMOLECULES, pp. 1950-1955 (1984), incorporated herein by reference. The designation “m” or “r” describes the stereochemistry of pairs of contiguous propylene groups, “m” referring to meso, and “r” to racemic. An m/r ratio of 1.0 generally describes a syndiotactic polymer, and an m/r ratio of 2.0 describes an atactic material.

The PBE may have a percent crystallinity of about 0.5% to about 40%, from about 1% to about 30%, or from about 5% to about 25%, determined according to DSC procedures. Crystallinity can be determined by dividing the Hf of a sample by the Hf of a 100% crystalline polymer, which is assumed to be 189 J/g for isotactic polypropylene.

The PBE may have a density of about 0.84 g/cm³ to about 0.92 g/cm³, from about 0.85 g/cm³ to about 0.90 g/cm³, or from about 0.85 g/cm³ to about 0.87 g/cm³ at room temperature (about 23° C.), as measured per the ASTM D-1505 test method.

The PBE can have a melt index (MI) (ASTM D-1238, 2.16 kg @ 190° C.), of less than or equal to about 100 dg/min, less than or equal to about 50 dg/min, less than or equal to about 25 dg/min, less than or equal to about 10 dg/min, less than or equal to about 8.0 dg/min, less than or equal to about 5.0 dg/min, or less than or equal to about 3.0 dg/min.

The PBE may have a melt flow rate (MFR), as measured according to ASTM D-1238 (2.16 kg weight @ 230° C.), greater than 0.5 dg/min, greater than 1.0 dg/min, greater than 1.5 dg/min, greater than 2.0 dg/min, or greater than 2.5 dg/min. The PBE may have an MFR less than 100 dg/min, less than 50 dg/min, less than 25 dg/min, less than 15 dg/min, less than 10 dg/min, less than 7 dg/min, or less than 5 dg/min. In some embodiments, the PBE may have an MFR from about 0.5 to about 10 dg/min, from about 1.0 to about 7 dg/min, or from about 1.5 to about 5 dg/min.

The PBE may have a g′ index value of 0.95 or greater, or at least 0.97, or at least 0.99, wherein g′ is measured at the Mw of the polymer using the intrinsic viscosity of isotactic polypropylene as the baseline. For use herein, the g′ index is defined as: g′=ηb/η1, where ηb is the intrinsic viscosity of the polymer and η1 is the intrinsic viscosity of a linear polymer of the same viscosity-averaged molecular weight (Mv) as the polymer. η1=KMvα, K and α are measured values for linear polymers and should be obtained on the same instrument as the one used for the g′ index measurement.

The PBE may have a weight average molecular weight (Mw), as measured by DRI, of about 50,000 to about 1,000,000 g/mol, or from about 75,000 to about 500,000 g/mol, from about 100,000 to about 350,000 g/mol, from about 125,000 to about 300,000 g/mol, from about 150,000 to about 275,000 g/mol, or from about 200,000 to about 250,000 g/mol.

The PBE may have a number average molecular weight (Mn), as measured by DRI, of about 5,000 to about 500,000 g/mol, from about 10,000 to about 300,000 g/mol, from about 50,000 to about 250,000 g/mol, from about 75,000 to about 200,000 g/mol, or from about 100,000 to about 150,000 g/mol.

The PBE may have a z-average molecular weight (Mz), as measured by MALLS, of about 50,000 to about 1,000,000 g/mol, or from about 75,000 to about 500,000 g/mol, or from about 100,000 to about 400,000 g/mol, from about 200,000 to about 375,000 g/mol, or from about 250,000 to about 350,000 g/mol.

The molecular weight distribution (MWD, equal to Mw/Mn) of the PBE can be from about 0.5 to about 20, from about 0.75 to about 10, from about 1.0 to about 5, from about 1.5 to about 4, or from about 1.8 to about 3.

Optionally, the PBE may also include one or more dienes. The term “diene” is defined as a hydrocarbon compound that has two unsaturation sites, e.g., a compound having two double bonds connecting carbon atoms. Depending on the context, the term “diene” as used herein refers broadly to either a diene monomer prior to polymerization, e.g., forming part of the polymerization medium, or a diene monomer after polymerization has begun (also referred to as a diene monomer unit or a diene-derived unit). In some embodiments, the diene can be selected from 5-ethylidene-2-norbornene (ENB); 1,4-hexadiene; 5-methylene-2-norbornene (MNB); 1,6-octadiene; 5-methyl-1,4-hexadiene; 3,7-dimethyl-1,6-octadiene; 1,3-cyclopentadiene; 1,4-cyclohexadiene; vinyl norbornene (VNB); dicyclopentadiene (DCPD), and combinations thereof. In embodiments where the PBE composition contains a diene, the diene can be present at from 0.05 wt % to about 6 wt %, from about 0.1 wt % to about 5.0 wt %, from about 0.25 wt % to about 3.0 wt %, from about 0.5 wt % to about 1.5 wt %, diene-derived units, where the percentage by weight is based upon the total weight of the propylene-derived, α-olefin derived, and diene-derived units.

Optionally, the PBE can be grafted (e.g., “functionalized”) using one or more grafting monomers. As used herein, the term “grafting” denotes covalent bonding of the grafting monomer to a polymer chain of the PBE. The grafting monomer can be or include at least one ethylenically unsaturated carboxylic acid or acid derivative, such as an acid anhydride, ester, salt, amide, imide, or acrylates. Illustrative grafting monomers include, but are not limited to, acrylic acid, methacrylic acid, maleic acid, fumaric acid, itaconic acid, citraconic acid, mesaconic acid, maleic anhydride, 4-methyl cyclohexene-1,2-dicarboxylic acid anhydride, bicyclo(2.2.2)octene-2,3-dicarboxylic acid anhydride, 1,2,3,4,5,8,9,10-octahydronaphthalene-2,3-dicarboxylic acid anhydride, 2-oxa-1,3-diketospiro(4.4)nonene, bicyclo(2.2.1) heptene-2,3-dicarboxylic acid anhydride, maleopimaric acid, tetrahydrophthalic anhydride, norbornene-2,3-dicarboxylic acid anhydride, nadic anhydride, methyl nadic anhydride, himic anhydride, methyl himic anhydride, and 5-methylbicyclo(2.2.1)heptene-2,3-dicarboxylic acid anhydride. Other suitable grafting monomers include methyl acrylate and higher alkyl acrylates, methyl methacrylate and higher alkyl methacrylates, acrylic acid, methacrylic acid, hydroxy-methyl methacrylate, hydroxyl-ethyl methacrylate and higher hydroxy-alkyl methacrylates and glycidyl methacrylate. Maleic anhydride is a grafting monomer. In embodiments, the graft monomer can be or include maleic anhydride, and the maleic anhydride concentration in the grafted polymer is in the range of about 1 wt % to about 6 wt %, such as at least about 0.5 wt %, or at least about 1.5 wt %.

In some embodiments, the PBE is a reactor blended polymer. That is, the PBE is a reactor blend of a first polymer component and a second polymer component. Thus, the comonomer content of the PBE can be adjusted by adjusting the comonomer content of the first polymer component, adjusting the comonomer content of second polymer component, and/or adjusting the ratio of the first polymer component to the second polymer component present in the PBE.

In embodiments where the PBE is a reactor blended polymer, the α-olefin content of the first polymer component can be greater than 5 wt % α-olefin, greater than 7 wt % α-olefin, greater than 10 wt % α-olefin, greater than 12 wt % α-olefin, greater than 15 wt % α-olefin, or greater than 17 wt % α-olefin, where the percentage by weight is based upon the total weight of the propylene-derived and α-olefin-derived units of the first polymer component. The α-olefin content of the first polymer component can be less than 30 wt % α-olefin, less than 27 wt % α-olefin, less than 25 wt % α-olefin, less than 22 wt % α-olefin, less than 20 wt % α-olefin, or less than 19 wt % α-olefin, where the percentage by weight is based upon the total weight of the propylene-derived and α-olefin-derived units of the first polymer component. In some embodiments, the α-olefin content of the first polymer component may range from 5 wt % to 30 wt % α-olefin, from 7 wt % to 27 wt % α-olefin, from 10 wt % to 25 wt % α-olefin, from 12 wt % to 22 wt % α-olefin, from 15 wt % to 20 wt % α-olefin, or from 17 wt % to 19 wt % α-olefin. In some examples, the first polymer component contains or comprises propylene and ethylene, and in some embodiments the first polymer component consists only of propylene and ethylene derived units.

In embodiments where the PBE is a reactor blended polymer, the α-olefin content of the second polymer component can be greater than 1.0 wt % α-olefin, greater than 1.5 wt % α-olefin, greater than 2.0 wt % α-olefin, greater than 2.5 wt % α-olefin, greater than 2.75 wt % α-olefin, or greater than 3.0 wt % α-olefin, where the percentage by weight is based upon the total weight of the propylene-derived and α-olefin-derived units of the second polymer component. The α-olefin content of the second polymer component can be less than 10 wt % α-olefin, less than 9 wt % α-olefin, less than 8 wt % α-olefin, less than 7 wt % α-olefin, less than 6 wt % α-olefin, or less than 5 wt % α-olefin, where the percentage by weight is based upon the total weight of the propylene-derived and α-olefin-derived units of the second polymer component. In some embodiments, the α-olefin content of the second polymer component may range from 1.0 wt % to 10 wt % α-olefin, or from 1.5 wt % to 9 wt % α-olefin, or from 2.0 wt % to 8 wt % α-olefin, or from 2.5 wt % to 7 wt % α-olefin, or from 2.75 wt % to 6 wt % α-olefin, or from 3 wt % to 5 wt % α-olefin. In some examples, the second polymer component contains propylene and ethylene, and in some embodiments the first polymer component consists only of propylene and ethylene derived units.

In certain embodiments, the PBE contains propylene-derived units and about 5 wt % to about 30 wt % of α-olefin-derived units and has a melting temperature of less than 120° C. and a heat of fusion of less than 75 J/g.

In certain embodiments, the PBE contains propylene-derived units and about 15 wt % to about 30 wt % of one or more alpha-olefin derived units, and has a MFR of at least 40 dg/min and a heat of fusion (Hf) of about 3 J/g to about 75 J/g, as determined by DSC.

In embodiments where the PBE is a reactor blended polymer, the PBE may contain from 1 wt % to 25 wt % of the second polymer component, from 3 wt % to 20 wt % of the second polymer component, from 5 wt % to 18 wt % of the second polymer component, from 7 wt % to 15 wt % of the second polymer component, or from 8 wt % to 12 wt % of the second polymer component, based on the weight of the PBE. The PBE may contain from 75 wt % to 99 wt % of the first polymer component, from 80 wt % to 97 wt % of the first polymer component, from 85 wt % to 93 wt % of the first polymer component, or from 82 wt % to 92 wt % of the first polymer component, based on the weight of the PBE.

In one or more embodiments, the PBE contains a reactor blend of a first polymer component and a second polymer component. The first polymer component contains propylene and an α-olefin and has an α-olefin content of greater than 5 wt % to less than 30 wt % of the α-olefin, based on the total weight of the propylene-derived and α-olefin derived units of the first polymer component. The second polymer component contains propylene and α-olefin and has an α-olefin content of greater than 1 wt % to less than 10 wt % of the α-olefin, based on the total weight of the propylene-derived and α-olefin derived units of the second polymer component. In one or more examples, the first polymer component has an α-olefin content of about 10 wt % to about 25 wt % of the α-olefin, based on the total weight of the propylene-derived and α-olefin derived units of the first polymer component. The second polymer component has an α-olefin content of greater than 2 wt % to less than 8 wt % of the α-olefin, based on the total weight of the propylene-derived and α-olefin derived units of the second polymer component. In other examples, the PBE contains about 1 wt % to about 25 wt % of the second polymer component and about 75 wt % to about 99 wt % of the first polymer component, based on the weight of the PBE.

The PBE can be prepared by any suitable means as known in the art. The PBE can be prepared using homogeneous conditions, such as a continuous solution polymerization process, using a metallocene catalyst. In some embodiments, the PBE are prepared in parallel solution polymerization reactors, such that the first reactor component is prepared in a first reactor and the second reactor component is prepared in a second reactor, and the reactor effluent from the first and second reactors are combined and blended to form a single effluent from which the final PBE is separated. Exemplary methods for the preparation of PBEs can be found in U.S. Pat. Nos. 6,881,800; 7,803,876; 8,013,069; and 8,026,323 and PCT Publications WO 2011/087729; WO 2011/087730; and WO 2011/087731.

### Polypropylene

The terms “polypropylene,” “propylene polymer,” and “propylene-based polymer” refer to a polymer or copolymer comprising at least 50 mol % propylene units (preferably at least 70 mol % propylene units, more preferably at least 80 mol % propylene units, even more preferably at least 90 mol % propylene units, even more preferably at least 95 mol % propylene units or 100 mol % propylene units (in the case of a homopolymer)).

The polypropylene can be or can include homopolypropylene (“hPP”), isotactic polypropylene, highly isotactic polypropylene, syndiotactic polypropylene, as well as copolymers of propylene or mixtures thereof. Products that include one or more propylene monomers polymerized with one or more additional monomers can be more commonly known as random copolymers (RCP) or impact copolymers (ICP). Impact copolymers may also be known in the art as heterophasic copolymers. “Propylene-based,” as used herein, is meant to include any polymer containing propylene, either alone or in combination with one or more comonomers, in which propylene is the major component (e.g., greater than 50 wt % propylene).

The term “random polypropylene” as used herein broadly means a single phase copolymer of propylene having up to 9 wt %, preferably 2 wt % to 8 wt % of an alpha olefin comonomer. Preferred alpha olefin comonomers have 2 carbon atoms, or from 4 to 12 carbon atoms. Preferably, the alpha olefin comonomer is ethylene.

“Reactor grade,” as used herein, means a polymer that has not been chemically or mechanically treated or blended after polymerization in an effort to alter the polymer's average molecular weight, molecular weight distribution, or viscosity. Particularly excluded from those polymers described as reactor grade are those that have been visbroken or otherwise treated or coated with peroxide or other prodegradants. For the purposes of this disclosure, however, reactor grade polymers include those polymers that are reactor blends.

The weight average molecular weight (Mw) of the polypropylene can be between 50,000 to 3,000,000 g/mol, or from 90,000 to 500,000 g/mol, with a molecular weight distribution (MWD, Mw/Mn) within the range from 1.5 to 2.5 or 3.0 or 4.0 or 5.0 or 20.0. The polypropylene can have an MFR (2.16 kg/230° C.) within the range from 10 or 15 or 18 to 30 or 35 or 40 or 50 dg/min.

### Foaming Agent

Foaming agents can include, but are not limited to, decomposable chemical foaming agents and physical foaming agents. Physical foaming can include a gas, such as air, nitrogen, carbon dioxide, etc., which can be injected into the composition during the injection molding process. Chemical foaming agents decompose at elevated temperatures to form gases or vapors to blow the polymer into foam form. Suitable chemical foaming agents can include, but are not limited to, organic foaming agents, such as 4,4′-oxybis benzene sulfonyl hydrazide; azodicarbonamide; azobisformamide; azobisisobutyronitrile; diazoaminobenzene; N,N-dimethyl-N,N-dinitroso terephthalamide; N,N-dinitrosopentamethylene-tetramine; benzenesulfonyl-hydrazide; benzene-1,3-disulfonyl hydrazide; diphenylsulfon-3-3, disulfonyl hydrazide; p-toluene sulfonyl semicarbizide; barium azodicarboxylate; butylamine nitrile; nitroureas; trihydrazino triazine; phenyl-methyl-uranthan; p-sulfonhydrazide; peroxides; and inorganic foaming agents such as ammonium bicarbonate and sodium bicarbonate.

The foaming agent can be employed in an amount of less than or equal to about 25 wt %, less than or equal to about 20 wt %, less than or equal to about 15 wt %, less than or equal to about 10 wt %, or less than or equal to about 6 wt %, relative to the total amount of polymer to be foamed. In some embodiments, the foaming agent may be used in an amount of about 0.1 wt % to 25 wt %, about 0.2 wt % to 20 wt %, about 0.3 wt % to 15 wt %, about 0.4 wt % to 10 wt %, or 0.5 wt % to about 6 wt %, relative to the total amount of PBE and compolymer to be foamed.

The foamed composition can be made or formed by any useful discrete molding or continuous extrusion means for forming and shaping polyolefins known in the art, including: single screw compounding, twin screw compounding, kneader/banbury mixing, sheet extrusion, profile extrusion or co-extrusion, compression molding, injection molding, co-injection molding, gas-assisted injection molding, transfer molding, foam molding, transfer molding, vacuum forming, lamination, calendering, or other forms of processing.

In one embodiment, the composition can be extruded from an extruder into pellets, or sheet-like shape or the like (molding step), and the extruded composition can be heated and foamed (foaming step). During the foaming step, the composition can be inserted into a pre-heated chamber or autoclave at a temperature in a range of, e.g., 40 to 200° C., or 60 to 160° C. then heated at a temperature of not more than 450° C., or in the range of 100 to 400° C., or 120 to 350° C. for, e.g., 1 to 80 minutes, or 2 to 50 minutes, or 1 minutes to 10 hours, or from about 0.5 hours to 8 hours, or from about 1 hours to about 6 hours, or from 2 hours to 6 hours. Alternatively, using a press, the prepared composition can be molded into a sheet-like shape, while being heated, to be foamed (foaming step) at opening of the press.

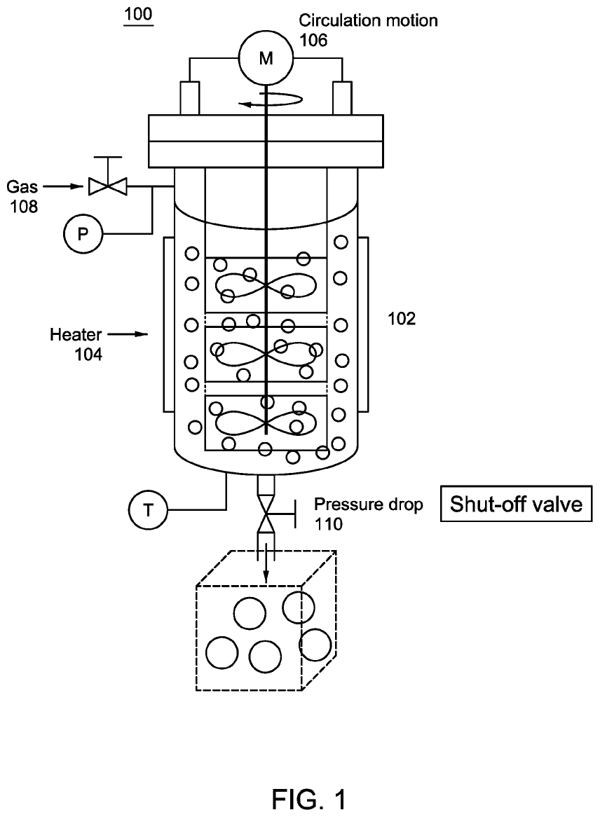

FIG. 1 illustrates an example device 100 for forming foamed beads from extruded pellets. Pellets and water are enclosed in a high-pressure stainless vessel 102 equipped with a heating system 104. In an embodiment, water inside vessel 102 serves as a heat transfer medium. The pellets and water were stirred by stirrer 106. A gas, such as CO₂, is charged into the vessel via an outlet 108 to reach to a desired pressure within the vessel. Then the vessel 102 is heated to a target temperature by the heater 104. At the target temperature, the vessel 102 is held for certain time to allow gas saturation. Next, the vessel 102 is depressurized by opening the shut-off value 110 and foam beads are obtained in a collection device 112.

Other examples of molding and foaming processes are disclosed in US Publication No. 20200181350.

Due to its relatively low molecular weight and thermoplastic nature, the propylene-based elastomer in the composition described herein reduces the density of the foamed product made therefrom by facilitating gas expansion and creating larger open cells during the foaming step.

The composition described herein can include at least 20 wt % of the one or more PBEs, based on a total weight of the composition. The composition can also include at least 22 wt %, at least 25 wt %, at least 30 wt %, at least 40 wt %, or at least 50 wt % of the one or more PBEs, based on a total weight of the composition. The composition can also contain one or more PBEs in an amount ranging from a low of about 20 wt %, 25 wt %, or 30 wt % to a high of about 75 wt %, 85 wt %, or 95 wt %, the balance being one or more polypropylenes.

In some embodiments, the composition includes one or more propylene-based elastomers in an amount of at least 20 wt %, based on the total weight of the composition, and provides a foamed product made therefrom with a density (ASTM D792-08, 23° C.) at least 5%, at least 7%, at least 10%, or at least 12% lower than the density of a comparative foamed product made with polystyrene, polypropylene or RCP.

The composition can have a flexural modulus (ISO 178) of at least 200 MPa. The flexural modulus can also be at least 300 MPa, at least 500 MPa, at least 700 MPa, at least 900 MPa, at least 1100 MPa or at least 1300 MPa. The flexural modulus can also range from a low of about 300, 500 or 600 to a high of about 800, 1000 or 1500 MPa. The composition can have a Notched izod impact (ISO 180) of at least 5 KJ/m² at 23° C., a Tensile stress at Yield based on ISO 527 of at least 10 MPa, and a Tensile Strain at Yield of at least 4%.

The composition can have a Vicat softening point (ASTM D 1525-07) of at least 45° C., at least 50° C., at least 60° C., at least 80° C., at least 95° C., at least 110° C., at least 130° C., or at least 150° C. The Vicat softening point can also range from a low of about 45, 50, 60, 80, 100, or 115 to a high of about 130, 150, or 170° C.

The composition can also have any combination of two or more of the foregoing density, flexural modulus (ISO 178), Vicat softening points (ASTM D 1525-07), Notched izod impact (ISO 180), and Tensile stress at Yield and Tensile Strain at Yield based on ISO 527.

The foam beads produced using the compositions described herein can have an average cell size of about 3 mm or less, preferably about 2 mm or less, preferably 1 mm or less according to ASTM D3576-04. Alternatively, the cell size can be between 10 microns to 10 mm, preferably from 100 microns to 5 mm.

Expanded foam beads (“EFB”) made from the composition provided herein can have a density of 0.140 g/cm³ or less. The EFBs preferably have a density less than 0.135, 0.130, 0.120, or 0.110 g/cm³. The EFBs can have a density ranging from a low of about 0.03, 0.05, 0.07 or 0.08 g/cm³ to high of about 0.11, 012, 0.10, or 0.14 g/cm³.

In the above detailed description, the specific embodiments of this disclosure have been described in connection with its preferred embodiments. However, to the extent that the above description is specific to a particular embodiment or a particular use of this disclosure, this is intended to be illustrative only and merely provides a concise description of the exemplary embodiments. Accordingly, the disclosure is not limited to the specific embodiments described above, but rather, the disclosure includes all alternatives, modifications, and equivalents falling within the true scope of the appended claims. Various modifications and variations of this disclosure will be obvious to a worker skilled in the art and it is to be understood that such modifications and variations are to be included within the purview of this application and the spirit and scope of the claims.

### EXAMPLES

Embodiments discussed and described herein can be further described with the following examples. Although the following examples are directed to specific embodiments, they are not to be viewed as limiting in any specific respect.

### Example 1

Two plate sheets were injection molded and then foamed to test the physical capabilities of the unblended polymer. Sheet #1 was made from a first propylene based compolymer (PBE1) having a melt index at 230° C./2.16 kg of 3 g/10 min and a density of 0.862 g/cm³, and was obtained from ExxonMobil. Sheet #2 was made from a second propylene based compolymer (PBE2) having a melt index at 230° C./2.16 kg of 8 g/10 min and a density of 0.879 g/cm³, also obtained from ExxonMobil.

The polymer was injection molded into plates and inserted into a preheated mold of a Wuxi Jinhe ( [symbol] [symbol] ) compression mold foaming machine. Table 1 summarizes the processing parameters and conditions.

TABLE 1
Processing parameters and conditions

| | | |
|---|---|---|
| Sample No. | Sheet #1 | Sheet #2 |

| | |
|---|---|
| Blowing agent | Carbon dioxide |

| | | | |
|---|---|---|---|
| Gas pressure | Present value/ | 8.1 | 7.6 |
| | MPa | | |
| | Set Value (High)/ | 8.5 | 8.0 |
| | MPa | | |
| | Set Value (High)/ | 8.0 | 7.5 |
| | MPa | | |
| Mold temperature | Present value/° C. | 75 | 74.8 |
| | Set value/° C. | 75 | 75 |

| | | |
|---|---|---|
| Clamping force/MPa | 10 | 10 |
| Foaming time/second | 900 | 600 |
| Gas release time/second | 402 | 660 |
| Density of foamed sheet (g/cm³) | 0.1343 | 0.1094 |

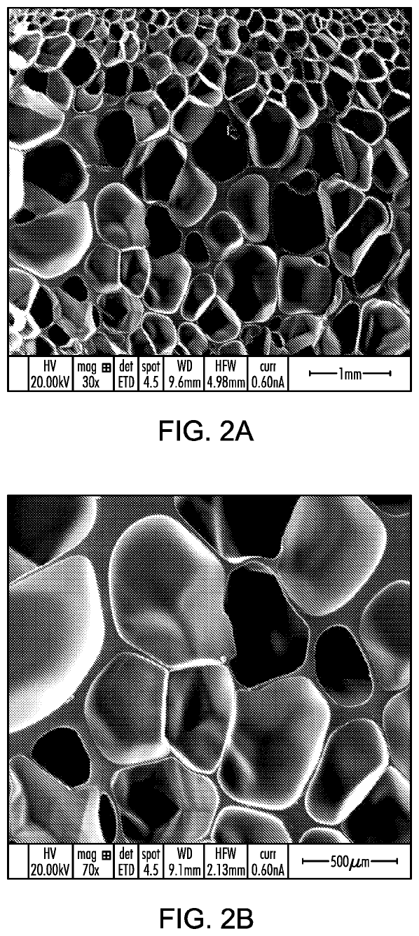

FIG. 2A shows a SEM of the foamed Sheet #1, and FIG. 2B is an enlarged view of the SEM depicted in FIG. 2A.

### Example 2

Expanded foam beads (“EFB”) were also made. The polymer components used for these EFBs were the second propylene based copolymer (PBE2) having a melt index at 230° C./2.16 kg of 8 g/10 min and a density of 0.879 g/cm³, obtained from ExxonMobil; a third propylene based copolymer (PBE3) having a melt index at 230° C./2.16 kg of 8 g/10 min and a density of 0.889 g/cm³, obtained from ExxonMobil; a polypropylene homopolymer (hPP, tradename of PP T30S) having a melt index at 230° C./2.16 kg of 3 g/10 min, obtained from Sinopec; and a random copolymer (RCP, tradename of W331) having a melt index at 230° C./2.16 kg of 7 g/10 min and a density of 0.90 g/cm³, obtained from TPC. Table 2 below reports the EFB formulations and the flexural modulus (ISO 178), and Vicat softening points (ASTM D 1525-07) for each polymer formulation prior to foaming. Table 3 reports the Notched izod impact (ISO 180), Tensile Stress at Yield and Tensile Strain at Yield based on ISO 527 for each polymer formulation.

TABLE 2
Formulations

| | | | | | | | Vicat |
|---|---|---|---|---|---|---|---|
| | | | | | | Flexural | softening |
| | PBE3 | PBE2 | hPP | RCP | ICP | Modulus | point |
| Sample No. | (wt %) | (wt %) | (wt %) | (wt %) | (wt %) | MPa | ° C. |
| EFB-001 | 100 | 0 | 0 | 0 | 0 | 395.0 | 103.0 |
| EFB-002 | 30 | 0 | 70 | 0 | 0 | 1067 | 142.6 |
| EFB-003 | 50 | 0 | 50 | 0 | 0 | 851.7 | 127.0 |
| EFB-004 | 0 | 100 | 0 | 0 | 0 | — | — |
| EFB-005 | 0 | 20 | 80 | 0 | 0 | 983.1 | 147.4 |
| EFB-006 | 0 | 30 | 70 | 0 | 0 | 692.5 | 140.1 |
| EFB-007 | 0 | 40 | 60 | 0 | 0 | 541.4 | 127.8 |
| EFB-008 | 0 | 50 | 50 | 0 | 0 | 433.5 | 114.8 |
| EFB-009 | 0 | 60 | 40 | 0 | 0 | 327.3 | 97.9 |
| EFB-010 | 0 | 70 | 30 | 0 | 0 | 248.8 | 83.9 |
| EFB-011 | 0 | 0 | 100 | 0 | 0 | 1433 | 156.6 |
| EFB-012 | 0 | 0 | 0 | 100 | 0 | 1096 | 134.3 |
| EFB-013 | 30 | 0 | 0 | 70 | 0 | 849.8 | 122.9 |
| EFB-014 | 50 | 0 | 0 | 50 | 0 | 633.4 | 115.1 |
| EFB-015 | 0 | 0 | 0 | 0 | 100 | 1748 | 154.5 |
| EFB-016 | 0 | 30 | 0 | 0 | 70 | 837.2 | 136.1 |
| EFB-017 | 0 | 50 | 0 | 0 | 50 | 485.3 | 107.3 |
| EFB-018 | 30 | 0 | 0 | 0 | 70 | 1143 | 140.2 |
| EFB-019 | 50 | 0 | 0 | 0 | 50 | 877.1 | 123.3 |

TABLE 3
Test results of flexural modulus and vicat softening point

| | | |
|---|---|---|
| Notched izod | Tensile | Tensile |
| impact | stress at | strain at |
| KJ/m² | Yield | Yield |

| Sample No. | 23° C. | −20° C. | MPa | % |
|---|---|---|---|---|
| EFB-001 | 15.16 | 2.23 | 14.85 | 13.5 |
| EFB-002 | 7.65 | 2.34 | 28.25 | 12.15 |
| EFB-003 | 9.55 | 2.32 | 24.40 | 12.44 |
| EFB-004 | — | — | — | — |
| EFB-005 | 11.31 | 2.63 | 27.44 | 14.05 |
| EFB-006 | 12.74 | 2.20 | 24.15 | 14.59 |
| EFB-007 | 17.53 | 2.91 | 20.6 | 15.73 |
| EFB-008 | 47.02 | 3.48 | 17.87 | 16.50 |
| EFB-009 | 65.04 | 3.46 | 15.07 | 16.50 |
| EFB-010 | 62.77 | 3.13 | 12.44 | 17.31 |
| EFB-011 | 5.55 | 2.43 | 33.87 | 9.025 |
| EFB-012 | 6.33 | 2.42 | 28.58 | 10.82 |
| EFB-013 | 7.71 | 2.58 | 23.24 | 12.15 |
| EFB-014 | 9.64 | 2.73 | 20.35 | 12.71 |
| EFB-015 | 8.42 | 4.22 | 32.02 | 5.285 |
| EFB-016 | 44.04 | 4.48 | 23.71 | 12.87 |
| EFB-017 | 59.79 | 4.54 | 16.93 | 15.58 |
| EFB-018 | 11.31 | 3.69 | 28.44 | 9.355 |
| EFB-019 | 13.35 | 3.39 | 24.9 | 10.79 |

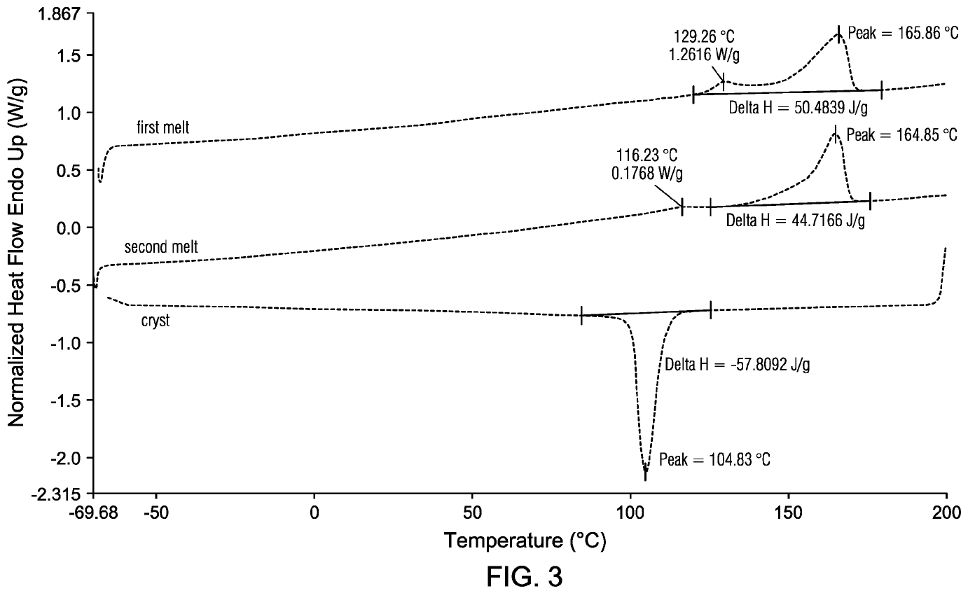

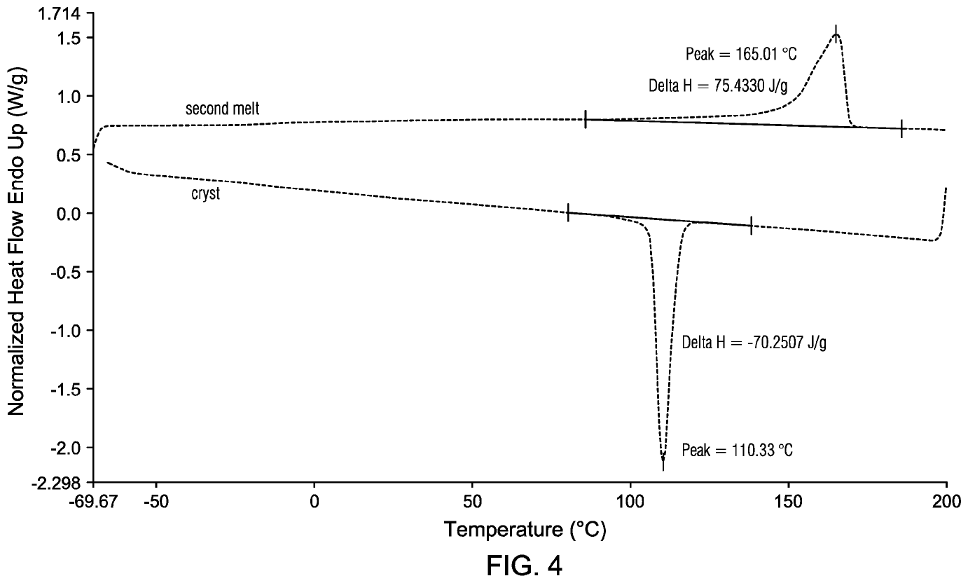

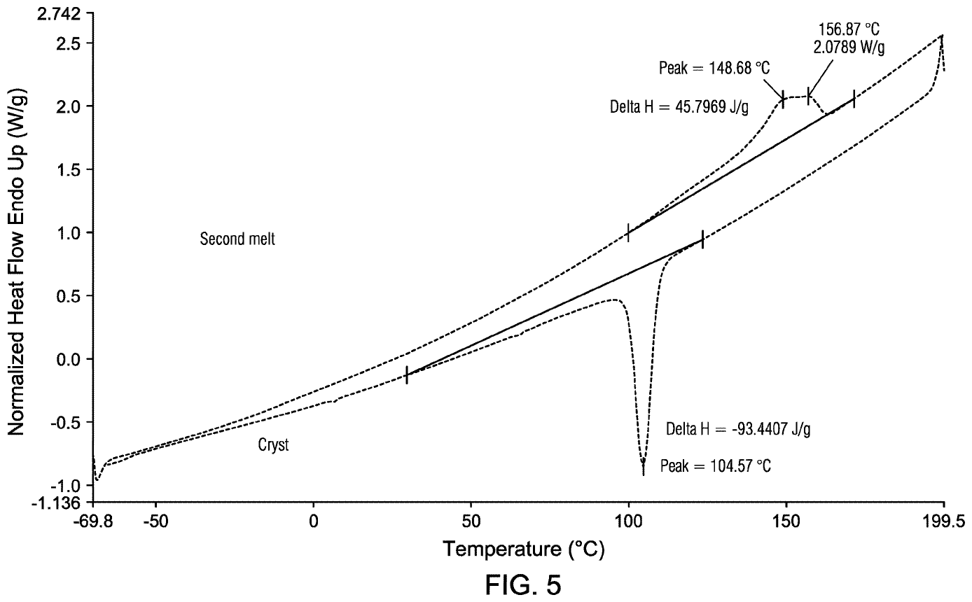

5 FIGS. 3, 4 and 5 show the DSC curves (based on ASTM D 3418) for the EFB-003, EFB-006 and EFB-013 samples. According to the curves, both the EFB-003 and EFB-006 samples had a melting peak of around 165° C., and the EFB-013 sample had a melting peak of around 150° C. Samples EFB003, EFB-006 and EFB-013 were chosen to do an industrial expanded foaming beads trial and steam molding trial. Each of EFB003, EFB-006 and EFB-013 were first compounded using a twin-screw extruder. The compounded materials were then pelletized to mirco-pellets having a width of about 1 mm width and a length of about 1.2 mm. Micro-pellets of each of EFB003, EFB-006 and EFB-013 were then foamed into beads using an auto-clave. Carbon dioxide was used as the foaming agent.

TABLE 4
Features of the selected expanded foam beads

| Sample No. | EFB-003 | EFB-006 | EFB-013 |
|---|---|---|---|
| Foaming agent | CO₂ | | |
| Dispersion agent | Water | | |
| Foaming temperature ° C. | 161 | 160.5 | 151 |

| | | |
|---|---|---|
| Expansion rate | ~18 times | ~16 times |

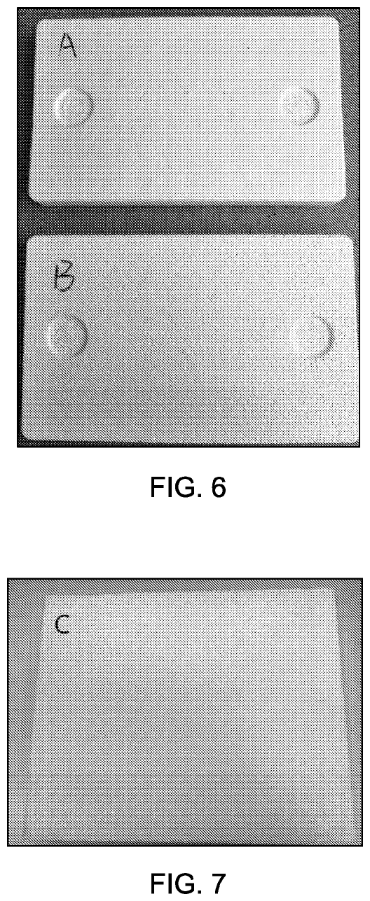

The foamed beads were then molded using steam at different pressure. FIG. 6 shows photographs of the EFB-003 and EFB-006 samples after being steam molded at 1.6 bar steam pressure. Notice the EFB-003 sample had a better surface compared to the EFB-006 sample. This shows that EFB-003 is more suitable for molding at this 1.6 bar steam pressure. FIG. 7 shows a photograph of the EFB-013 sample after being steam molded at 1.4 bar. In addition, this significant reduction in steam pressure compared to the normal 2-3 bar needed for conventional ethylene-propylene copolymer products provides significant costs savings.

Steam molded sample of EFB-003 at 1.8 bar steam pressure and steam molded sample of EFB-013 was tested for mechanical performance. Table 5 and Table 6 summarize the results of compression strength (based on GB/T 8813) and tensile property (based on GB/T 6344).

TABLE 5
Compression strength of steam molded sample.

| | | | Steam | 10% | 25% | 50% | 75% |
|---|---|---|---|---|---|---|---|
| | | | molding | Compression | Compression | Compression | Compression |
| Sample | Expansion | Density | pressure | strength | strength | strength | strength |
| No. | ratio | g/cm³ | bar | Mpa | Mpa | Mpa | Mpa |
| EFB-003 | 18 times | 0.0050 | 1.8 | 0.17 | 0.22 | 0.34 | 0.79 |
| EFB-013 | 16.6 times | 0.0054 | 1.4 | 0.16 | 0.22 | 0.35 | 0.88 |

TABLE 6
Tensile properties of steam molded sample

| | | | Steam | Tensile | |
|---|---|---|---|---|---|
| | | | molding | strength at | Elongation at |
| Sample | Expansion | Density | pressure | break | break |
| No. | ratio | g/cm³ | bar | Mpa | % |
| EFB-003 | 18 times | 0.0050 | 1.8 | 0.62 | 18.2 |
| EFB-013 | 16.6 | 0.0054 | 1.4 | 0.51 | 15.0 |

### Example 3

EFBs including a single polymer component were also made. The polymer component used for these EFBs was PBE3. First, the PBE3 was drawn into filaments through extruders and pelletized. The pellets had a diameter of about 1 mm. Then, the PBE3 pellets were foamed. Water, PBE3 particles and isolation agent were added to the foam kettle and all valves were closed. CO₂ was injected into the foam kettle, and then the foam kettle began to heat. The foaming temperature was 109° C. and the foaming pressure was 3.0 MPa. When the temperature and pressure reach the set value, the discharge valve was opened. The composite particles were removed from the foam kettle along with the airflow and formed into foam bead. The foam beads were dried on a fluidized bed dryer at 50-80° C. for 1 hour and the foam bead product is obtained. Foam density of the bead was 0.074 g/cm³, volumetric expansion ratio of foam was about 13.5 times. The foam particles were smooth, full and uniform in size.

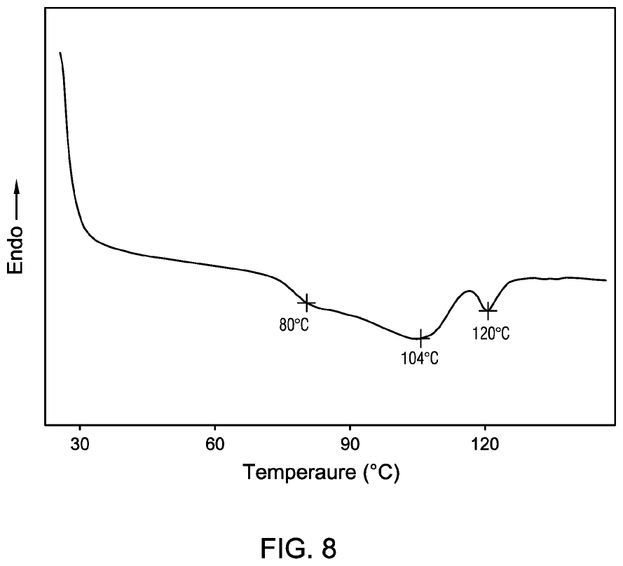

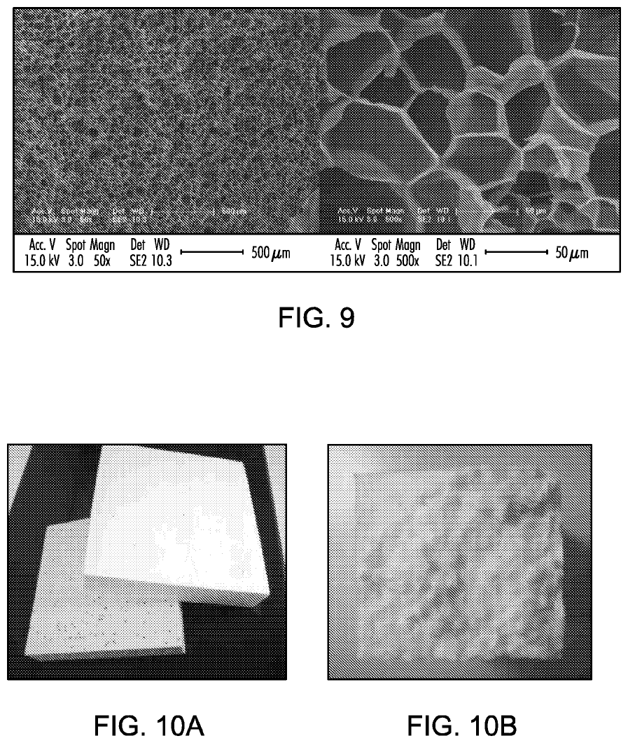

Melting points of the PBE3 EFBs were determined by DSC, performed on a Perkine-Elmer DSC-7 instrument, using a heating rate of 20° C./min in the temperature range 25-150° C. The measurements were carried out under N₂ atmosphere. The mass of the sample was 5-10 mg. As can be seen from the DSC melting curve in FIG. 8, there was an obvious multi-stage melting behavior. The melting points were 80° C., 104° C. and 120° C., respectively, which is conducive to foam steam forming. The PFP3 EFBs were fractured, and the fracture surfaces were observed under PHILLIPS XL30ESEM FEG field emission scanning electron microscope. As can be seen in FIG. 9, the cells were uniform. The cell size was about 36.7 μm, and the cell density was 3.3×10⁸.

The PBE3 EFBs were then molded into plaques. The PBE3 EFBs were firstly pre-pressed for 6 h and 0.06 MPa in a pre-pressed tank and then sent to a hopper of a molding machine for steam-chest forming. The molding machine was operated according to a fixed procedure to execute the cycle of steam-chest molding process. First the mold was closed, foam beads flowed into the mold with air, steam ran through mold from left side, steam ran through mold from right side, steam was added from both sides at same time, the sample cooled using water, the mold was automatically opened, and finally the samples were automatically demoulded. The steam-chest molding pressure was set to 0.1-0.12 MPa, the time of each adding stage was 2~4s, the time of water cooling was 150 s.

Under such conditions, a good steam-chest forming product was obtained, as shown in FIG. 10A. The product was uniform, showing smooth surface properties. The bond between the foam beads was very good as shown in FIG. 10B. The foam beads were well fused together, no obvious boundary was shown. Thus, for the steam consumption, PBE3 foam showed a low steam-chest molding temperature and molding time as compared to EPS foam at molding conditions close to those of EPS foams.

Mechanical properties of the steam molded product was conducted in accordance with the method described in the Chinese standard GB 8813. The compression strength at 25% was 0.138±0.014 MPa, at 50% was 0.235±0.022 MPa and at 75% was 0.552±0.051 MPa. The tensile strength was 52.3±4.2 MPa and elongation at tensile break was 88±7%.

PBE3 polymer, when used alone to form EFB, shows a wide Tₘ range and good foamability. Due to the chain structure similarity of PBE3 and PP, PBE3 shows good miscibility with PP. This indicates that PBE3 can shift the Tₘ of the foam bead to a lower temperature range as compared to PP alone. Thus, a PP-PBE3 foam bead could realize good fusion under low T/low steam chest pressure, and result in significant energy savings and equipment cost savings.

### Example 4

Expanded foam beads were created using PBE2 and PBE3 pellets. PBE2 and PBE3 pellets and water were each separately enclosed in a high pressure stainless vessel equipped with a heating system. Water was used as a heat transfer medium. In an appropriate stirring speed, 200 r/min, CO₂ was charged into the vessel to reach to a desired pressure. Then the chamber was heated to a target temperature. At target temperature, the chamber was held for certain time for CO₂ saturation. After that, the depressurization occurred by opening the shut-off value and bead foam were obtained in a collection device.

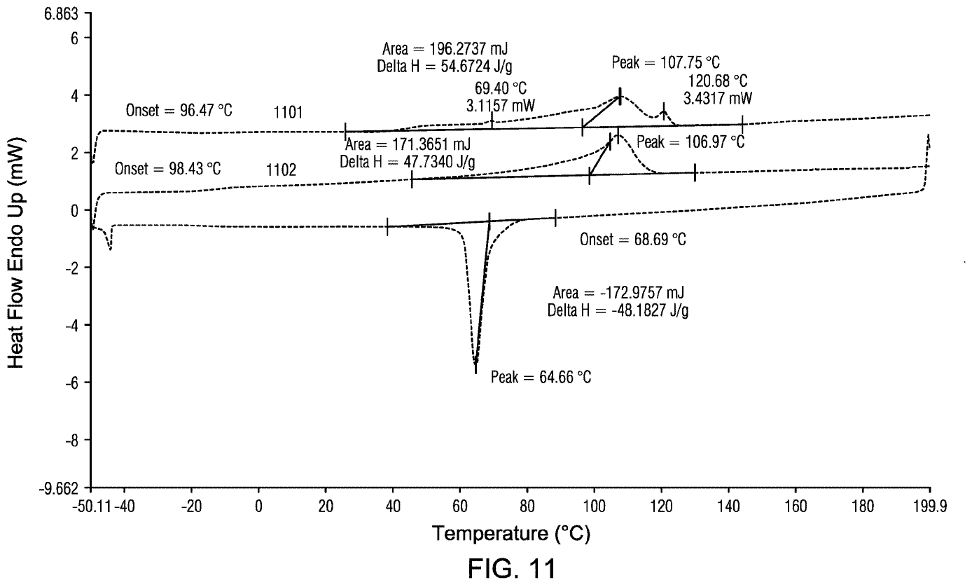

DSC was used to investigate the thermal behavior of foamed PBE bead. As shown for PBE3 in FIG. 11, two evident endothermic peaks were observed at the first heating curve (line 1101). The lower peak at 108° C. is comparatively broader than the higher peak at 121° C. In contrast, in second heating curve (line 1102), which provides the information of pristine polymer without thermal history, only one peak is found at 107° C. The difference between first and second melting curve indicates two crystal structures with different stability are formed during foaming process. This result indicates that the stream compression molding process can be targeted near the lower melting peak, such that the foamed beads can be partially melted at the surface and then fuse with each other while keeping their original shapes.

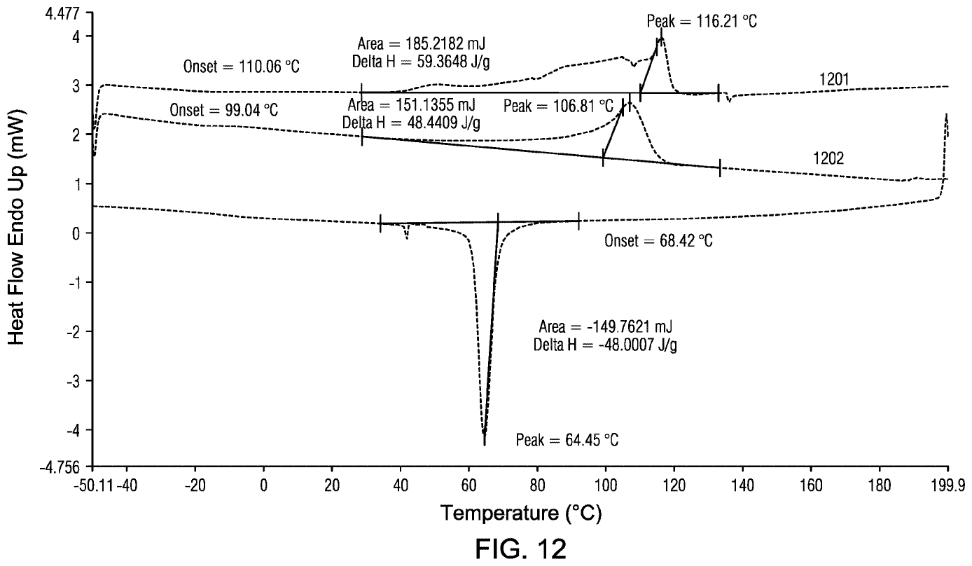

Similarly, same phenomenon is observed in the DSC curve of PBE2 in FIG. 12. For the first heating curve (line 1201), the lower peak is around 107° C. and the higher peak is at 116° C. In contrast, the melting point of pristine polymer is at 107° C. according to second heating curve (line 1202). The results indicate that both foamed PBE2 and PBE3 can form two melting peaks which are important on their post stream compression molding process.

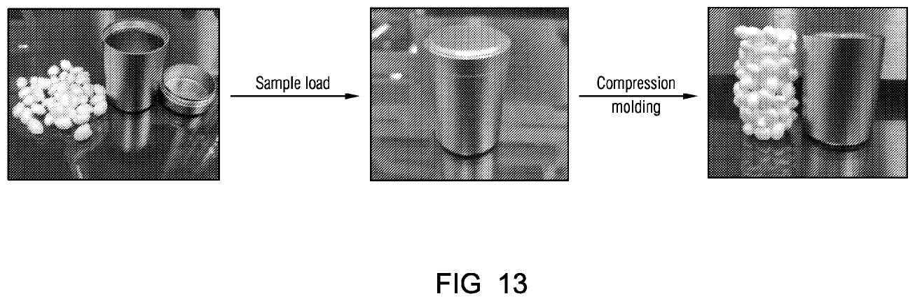

A simple experiment to simulate the molding process was designed, as shown in FIG. 13. The foamed PBE beads were fully loaded into a stainless can with a screw cap. After the cap is twisted tightly, foamed beads were in a compressed state. Then, the can was put in oven at certain temperature for a time and then taken out of the oven for cooling. The molded beads were then taken out of the can to check the fusion quality and appearance. PBE3 was held in an oven at 110° C. for 7 min. PBE2 was held in an oven at 95° C. for 6 min.

This Example shows that, for PBE2 and PBE3 foamed pellets exhibit a dual-peak melting behavior that can be used to define a target temperature window for compression molding within which the foam bead surface will adhere, but the foam bead structure is preserved.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, meaning the values take into account experimental error, machine tolerances and other variations that would be expected by a person having ordinary skill in the art.

The foregoing has also outlined features of several embodiments so that those skilled in the art can better understand the present disclosure. Those skilled in the art should appreciate that they can readily use the present disclosure as a basis for designing or modifying other methods or devices for carrying out the same purposes and/or achieving the same advantages of the embodiments disclosed herein. Those skilled in the art should also realize that such equivalent constructions do not depart from the spirit and scope of the present disclosure, and that they can make various changes, substitutions, and alterations herein without departing from the spirit and scope of the present disclosure, and the scope thereof is determined by the claims that follow.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention can be devised without departing from the basic scope thereof, and the scope thereof is determined by the claims that follow.

What is claimed is:

1. A foamable polymer composition comprising:
(a) at least 5 wt %, based on the total weight of the composition, of at least one propylene-based elastomer comprising propylene and about 15 wt % to about 30 wt % of one or more alpha-olefin derived units, based on a total weight of the elastomer, wherein the propylene-based elastomer has a MFR of at least 3 g/10 min and a heat of fusion (Hf) of about 3 J/g to about 75 J/g, as determined by DSC;
(b) less than 95 wt %, based on the total weight of the composition, of at least one polypropylene; and
(c) a foaming agent; wherein, prior to combination with the foaming agent, the polymer blend has a density of at least 0.80 g/cm³ and after the blend is foamed, the foamed article has a density of 0.2 g/cm³ or less.

2. The foamable polymer composition of claim 1, wherein the at least one propylene-based elastomer comprises at least 10 wt % of the foamable polymer composition.

3. The foamable polymer composition of claim 1, wherein the at least one propylene-based elastomer comprises at least 20 wt % of the foamable polymer composition.

4. The foamable polymer composition of claim 1, wherein the foaming agent is a gas.

5. The foamable polymer composition of claim 1, wherein the foaming agent is carbon dioxide.

6. The foamable polymer composition of claim 1, wherein the polypropylene comprises at least 70 wt % of propylene derived units.

7. A foamed bead comprising at least 80 wt %, based on the total weight of the foamed bead, of a propylene-based elastomer comprising propylene and about 15 wt % to about 30 wt % of one or more alpha-olefin derived units, based on a total weight of the elastomer, wherein the propylene-based elastomer has a MFR of at least 3 g/10 min and a heat of fusion (Hf) of about 3 J/g to about 75 J/g, as determined by DSC.

8. The foamed bead of claim 7, further comprising a foaming agent.

9. The foamed bead of claim 7, wherein the foamed bead has a melting temperature less than 111° C.

10. The foamed bead of claim 7, wherein the foamed bead has a melting temperature from 100-111° C.

11. An article comprising a plurality of the foamed beads of claim 7.

12. A process for producing a foamed polymer composition, comprising:
(a) mixing a foaming agent with a molten polymer composition to form a foamable mixture;
(b) forming said foamable mixture so that said foaming agent expands within said mixture to produce a foam; and
(c) obtaining a foamed article having a density of 0.11 g/cm³ or less, wherein the molten polymer composition comprises the composition of claim 1.

13. The process of claim 12, wherein the foamed article has an averaged cell size of 1 mm or less.

14. A process for producing a foamed bead article, comprising:
introducing a plurality of foamed beads to a mold;
increasing the pressure within the mold to an elevated pressure from 0.1-0.5 MPa;
heating the foamed beads within the mold to an elevated temperature from 35-125° C.;
maintaining the elevated pressure and elevated temperature for a compression time to form the foamed bead article; and
releasing the article.

15. The process of claim 14, wherein the foamed beads are heated to a temperature from 90-115° C.

16. The process of claim 14, wherein the foamed beads are heated to a temperature of 110° C. or less.

17. The process of claim 14, wherein the elevated pressure is from 0.1-0.12 MPa.

18. The process of claim 14, wherein the compression time is from 5-10 minutes.
